(19) United States
(12) Patent Application Publication
(10) Pub. No.: US 2025/0165728 A1
(43) Pub. Date: May 22, 2025

(54) SUMMARIZATION WITH USER INTERFACE (UI) STREAM CONTROL AND ACTIONABLE INFORMATION EXTRACTION

(71) Applicant: GOOGLE LLC, Mountain Veiw, CA (US)

(72) Inventors: Ruofei Du, San Francisco, CA (US); Alex Olwal, Santa Cruz, CA (US); Vikas Bahirwani, San Francisco, CA (US); Boris Smus, Seattle, WA (US); Christopher Ross, Brooklyn, NY (US)

(21) Appl. No.: 18/862,092

(22) PCT Filed: May 10, 2023
(86) PCT No.: PCT/US2023/021769

§ 371 Date: Oct. 31, 2024

Related U.S. Application Data
(60) Provisional application No. 63/364,478, filed on May 10, 2022.

(51) Int. Cl. G06F 40/58

(52) U.S. Cl. CPC G06F 40/58

(57) ABSTRACT

Described techniques may be utilized to process transcribed text of a transcription stream using a summarization ML model to obtain a summary stream. In this way, a live conversation or other live speech may be provided to a user in real-time, using a display of a head-mounted device (HMD) or other suitable device. A user interface may be provided with a toggle or other stream selector for selecting either or both of the transcription stream or the summary stream at a given point in time. Actionable items may be identified within either or both of the transcription stream or the summary stream, and a scroll bar or other action selector may be provided in the user interface to execute corresponding actions.

### CROSS REFERENCE TO RELATED APPLICATIONS

This application claims the benefit of U.S. Provisional Application No. 63/364,478, filed May 10, 2022, the disclosure of which is incorporated herein by reference in its entirety.

This application also incorporates by reference herein the disclosures to related co-pending applications, U.S. application Ser. No. 18/315,113, filed May 10, 2023, “Multi-Stage Summarization for Customized, Contextual Summaries”, filed May 10, 2023 (Attorney Docket No. 0120-533WO1), “Dynamic Summary Adjustments for Live Summaries”, filed May 10, 2023 (Attorney Docket No. 0120-534WO1), “Summary Generation for Live Summaries with User and Device Customization”, filed May 10, 2023 (Attorney Docket No. 0120-535WO1), “Summarization with User Interface (UI) Stream Control and Actionable Information Extraction”, filed May 10, 2023 (Attorney Docket No. 0120-541WO1), and “Incremental Streaming for Live Summaries”, filed May 10, 2023 (Attorney Docket No. 0120-589WO1).

### TECHNICAL FIELD

This description relates to summarization using machine learning (ML) models.

### BACKGROUND

A volume of text, such as a document or an article, often includes content that is not useful to, or desired by, a consumer of the volume of text. Additionally, or alternatively, a user may not wish to devote time (or may not have sufficient time) to consume an entirety of a volume of text.

Summarization generally refers to techniques for attempting to reduce a volume of text to obtain a reduced text volume that retains most information of the volume of text within a summary. Accordingly, a user may consume information in a more efficient and desirable manner. In order to enable the necessary processing of the text, the latter may be represented by electronic data (text data). For example, a ML model may be trained to input text and output a summary of the text.

### SUMMARY

Described techniques process input text data to reduce a data volume of the input text data and obtain output text data expressing a summary of content of the input text data. The obtained, reduced volume of the output text data may be conformed to a size of a display, so as to optimize a size of the output text data relative to the size of the display. Moreover, described techniques may accomplish such customized data volume reductions with reduced delay, compared to existing techniques and approaches.

In a general aspect, a computer program product is tangibly embodied on a non-transitory computer-readable storage medium and comprises instructions. When executed by at least one computing device, the instructions may be configured to cause the at least one computing device to receive a transcription stream including transcribed text, input the transcription stream into a summarization machine learning (ML) model to obtain a summary stream including summarized text, and render, on a user interface (UI), a stream selector icon. When executed by the at least one computing device, the instructions may be configured to cause the at least one computing device to receive, via the stream selector icon, at least one selected stream of the transcription stream and the summary stream, and cause a display, on the UI, of the at least one selected stream.

According to another general aspect, a device includes at least one processor, at least one display, and at least one memory storing instructions. When executed by the at least one processor, the instructions cause the device to receive a transcription stream including transcribed text, input the transcription stream into a summarization machine learning (ML) model to obtain a summary stream including summarized text, render, on a graphical user interface (GUI), a stream selector icon, receive, via the stream selector icon, at least one selected stream of the transcription stream and the summary stream, cause a display, on the GUI, of the at least one selected stream.

According to another general aspect, a method includes receiving a transcription stream including transcribed text, inputting the transcription stream into a summarization machine learning (ML) model to obtain a summary stream including summarized text, and rendering, on a graphical user interface (GUT), a stream selector icon. The method further includes receiving, via the stream selector icon, at least one selected stream of the transcription stream and the summary stream, and causing a display, on the GUI, of the at least one selected stream.

According to another general aspect, a computer program product is tangibly embodied on a non-transitory computer-readable storage medium and comprises instructions. When executed by at least one computing device, the instructions may be configured to cause the at least one computing device to receive a transcription stream including transcribed text, input the transcription stream into a summarization machine learning (ML) model to obtain a summary stream of summarized text, and identify, within the summarized text, summarized content that is associated with at least one action. When executed by the at least one computing device, the instructions may be configured to cause the at least one computing device to render, on a graphical user interface (GUI), the summarized text with the summarized content included therein with an action indicator relating the summarized content to the at least one action, receive, via the GUI, a selection of the summarized content, and execute the at least one action, in response to the selection.

According to another general aspect, a device includes at least one processor, at least one display, and at least one memory storing instructions. When executed by the at least one processor, the instructions cause the device to receive a transcription stream including transcribed text, input the transcription stream into a summarization machine learning (ML) model to obtain a summary stream of summarized text, and identify, within the summarized text, summarized content that is associated with at least one action. When executed by the at least one processor, the instructions cause the device to render, on a graphical user interface (GUI), the summarized text with the summarized content included therein with an action indicator relating the summarized content to the at least one action, receive, via the GUI, a selection of the summarized content, and execute the at least one action, in response to the selection.

According to another general aspect, a method includes receiving a transcription stream including transcribed text, inputting the transcription stream into a summarization machine learning (ML) model to obtain a summary stream of summarized text, and identifying, within the summarized text, summarized content that is associated with at least one action. The method includes rendering, on a graphical user interface (GUI), the summarized text with the summarized content included therein with an action indicator relating the summarized content to the at least one action, receiving, via the GUI, a selection of the summarized content, and executing the at least one action, in response to the selection.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for summarization with UI stream control and actionable information extraction.

FIG. 2A is a flowchart illustrating first example operations of the system of FIG. 1.

FIG. 2B is a flowchart illustrating second example operations of the system of FIG. 1.

FIG. 3A is sequence of screenshots illustrating example operations of the system of FIG. 1.

FIG. 3B illustrates a pair of screenshots of the system of FIG. 1 at a first time.

FIG. 3C illustrates the pair of screenshots of FIG. 3B at a second time.

FIG. 3D illustrates a first alternate embodiment of the example of FIG. 3C.

FIG. 3E illustrates a second alternate embodiment of the example of FIG. 3C.

FIG. 3F illustrates a screenshot of a settings menu that may be used in the system of FIG. 1.

FIG. 4A illustrates a screenshot of an example summary of a first summary type.

FIG. 4B illustrates an alternative implementation of the example of FIG. 4A.

FIG. 4C illustrates a screenshot of an example summary of a second summary type.

FIG. 4D illustrates a screenshot of an example summary of a third summary type.

FIG. 5A illustrates example display layouts of the system of FIG. 1.

FIG. 5B illustrates a sequence of screenshots demonstrating action selection from summarized content.

FIG. 6A is an example screenshot of an alternate embodiment for action selection from summarized content.

FIG. 6B illustrates a sequence of screenshots demonstrating action selection from summarized content using a scrollbar.

FIG. 7 is a third person view of a user in an ambient computing environment.

FIGS. 8A and 8B illustrate front and rear views of an example implementation of a pair of smartglasses.

### DETAILED DESCRIPTION

Described systems and techniques enable user interface (UI) or graphical user interface (GUI) display and control of one or both of a transcription stream of transcribed text and/or a summary stream of summarized text that has been summarized from the transcribed text. For example, described techniques enable customized, contextual summary displays and associated stream control during a live conversation between a speaker(s) and a user. Input speech (audio data) received at a device during the live conversation may be transcribed to obtain a live transcription stream (a data stream) and further processed using at least one trained summarization model, or summarizer, to provide a summary of the speech. In this way, e.g., the above-referenced summary stream (a data stream) of captions that are updated as the speaker speaks may be provided. Described techniques may provide the user with an ability to easily see, interpret, modify, and otherwise utilize either or both of the transcription stream and the summary stream, along with various associated features. Accordingly, a user may have a fluid experience of the live conversation, in which the transcription stream and the summary stream assist the user in understanding the live conversation, even when the UI/GUI only comprises a limited size for displaying the transcription and/or summary stream.

Consequently, described techniques may be helpful, for example, when a user is deaf or heard of hearing, as the user may be provided with the transcription stream and/or the summary stream visually on a display. Similarly, when the user is attempting to converse with a speaker in a foreign language, the user may be provided with the summary stream in the user's native language. For example, one or both of the transcription stream and the summary stream may be translated into a desired language.

Described techniques may be implemented for virtually any type of spoken input text (text data). For example, automatic speech recognition (ASR), speech-to-text (STT), and/or other transcription techniques, may be used to provide a live transcription of detected speech, which may then be provided or available to a user as the transcription stream. Then, described UI techniques may be used to present the user with an ability to select and view the transcription stream, the summary stream, or both (e.g., in parallel or in series).

Moreover, described UI techniques may provide the user with various stream icons related to the transcription stream and the summary stream. For example, described UI techniques may provide a stream status (e.g., currently being processed), a stream type (e.g. transcription stream or summary stream), or a stream context (e.g., a context or type of the speech being transcribed, such as a lecture or a conversation). Described UI techniques may further provide the user with an ability to scroll through (e.g., backwards or forwards in time) one or both of the transcription stream and the summary stream, or to otherwise control aspects of the transcription stream and the summary stream.

Additionally, entities and other information may be identified within either or both of the transcription stream and the summary stream (e.g., using an entity extraction model), and described UI techniques may enable the user to select implementation and execution of an associated action for each entity. An entity may be a portion of text comprised in the selected stream. For example, the entity extraction may extract or identify a person named in the transcription stream or the summary stream, and the associated action may include adding the person to a contact list of the user. In another example, the entity extraction may identify a phone number in the transcription stream or the summary stream, and the associated action may be to call the phone number. The action may be a predetermined processing of data (e.g., based on the entity).

A rendering engine may be configured to render the transcription stream and the summary stream and associated stream icons, and to execute selections of the user made using the stream icons. Such a rendering engine may render content of the transcription stream and the summary stream in a manner that facilitates or enables use of the stream icons.

For example, the rendering engine may render the transcription stream and the summary stream with identified entities color-coded or otherwise visually highlighted in a manner designed to enable easy identification and selection of the identified entities. Accordingly, any actions associated with such entities may be designated and executed.

For example, a user wearing smartglasses or a smartwatch, or using a smartphone, may be provided with either/both a transcription stream and a summarization stream while listening to a speaker. In other examples, a user watching a video or participating in a video conference may be provided with either/both a transcription stream and a summarization stream.

Described techniques thus overcome various shortcomings and deficiencies of existing summarization techniques, while also enabling new implementations and use cases. For example, existing summarization techniques may reduce input text excessively, may not reduce input text enough, may include irrelevant text, or may include inaccurate information. In scenarios referenced above, in which a transcription stream and a summarization stream are desired to be provided in parallel, existing summarization techniques (in addition to the shortcomings just mentioned) may be unable to generate a desirable summary quickly enough, or may attempt to generate summaries at inopportune times (e.g., before a speaker has finished discussing a topic). Still further, existing techniques may generate a summary that is too lengthy (or otherwise maladapted) to be displayed effectively on an available display area of a device being used (e.g., smartglasses).

Moreover, existing techniques do not provide the types of UI-based display and control techniques described herein, so that provided captions, even if available, are of limited practical use. For example, existing techniques that attempt to provide live transcriptions may be unable to keep up with live speech, while not providing any available options for summarization.

In contrast, described techniques solve the above problems, and other problems, by, e.g., providing straightforward, intuitive UI-based use and control of either or both of a transcription stream and a summary stream. Consequently, described techniques are well-suited to implement dynamic, real-time summaries, in conjunction with a live transcription that is also produced and available to a user, while providing the user with information and functionality that facilitate use(s) of the available streams.

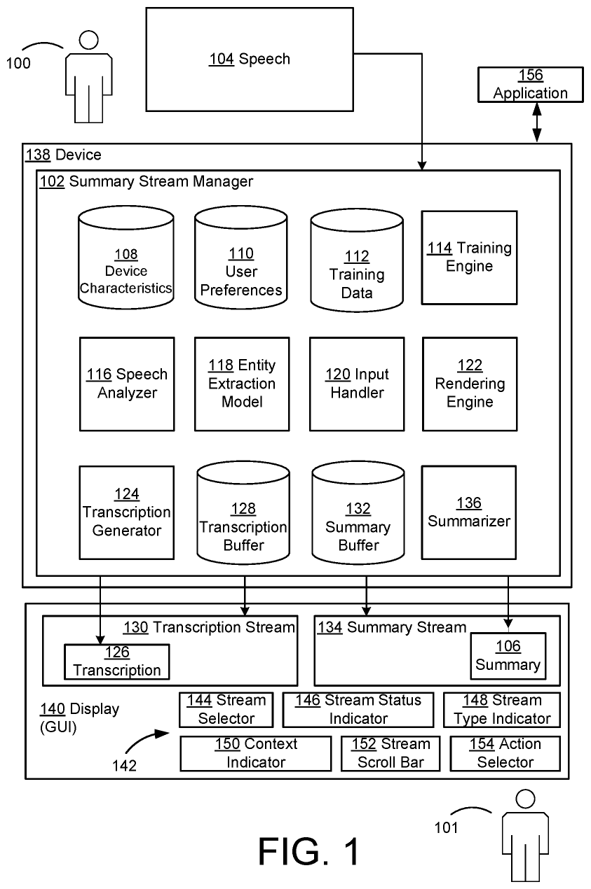

FIG. 1 is a block diagram of a system for summarization with UI stream control and actionable information extraction. In the example of FIG. 1, a summary stream manager 102 processes speech 104 (audio data, also referred to as spoken input) of a speaker 100 to obtain a summary 106 that is provided to a user 101 as part of a live, dynamically adjusted summary stream 134. As referenced above, the speech 104 may include virtually any spoken words or other spoken input. For example, the speech 104 may a lecture, a talk, a dialogue, an interview, a conversation, or any other spoken-word interaction of two or more participants. Such interactions may be largely one-sided (a monologue), such as in the case of a lecture, or may be an equal give-and-take between the speaker 100 (and perhaps other speakers, not shown in FIG. 1) and the user 101.

For example, a conversation may be conducted between the speaker 100 and the user 101, and the conversation may be facilitated by the summary stream manager 102. As just noted, in other examples, the speaker 100 may represent a lecturer, while the user 101 represents a lecture attendee, so that the summary stream manager 102 facilitates a utility of the lecture to the user 101. The speaker 100 and the user 101 may be co-located and conducting an in-person conversation, or may be remote from one another and communicating via web conference.

In other examples, the speaker 100 may record the speech 104 at a first time, and the user 101 may view (and receive the summary 106 of) the recorded audio and/or video at a later time. In this sense, the term ‘live conversation’ should be understood to be primarily from the perspective of the user 101. For example, as just noted, the user 101 may listen live to a video of the speaker 100 that was previously recorded, and be provided with the type of live, dynamically adjusted summary stream 134 described herein.

FIG. 1 should thus be understood to illustrate an ability of the summary stream manager 102 to provide the summary 106 in a stand-alone or static manner, in response to a discrete instance of the speech 104 (e.g., summarizing audio of a single recorded video). At the same time, FIG. 1 also illustrates an ability of the summary stream manager 102 to receive speech of the speaker 100 over a first time interval and output the summary 106 to the user 101, and then to repeat such speech-to-summary operations over a second and subsequent time interval(s) to provide the types of dynamic summarizations referenced above, and described in detail below with reference to the summary stream 134. In other words, as shown and described, the summary 106 may be understood to represent a single discrete summary of corresponding discrete speech of the speaker 100 within a single time interval of a larger time period or time window of a conversation.

As also described in detail, below, the summary stream manager 102 may be implemented in conjunction with any suitable device 138, such as a handheld computing device, smartglasses, earbuds, or smartwatch. For example, the summary stream manager 102 may be implemented in conjunction with one or more such devices in which a microphone or other input device is used to receive the speech 104, and an audio output, visual display (e.g., a display 140 in FIG. 1), and/or other output device(s) is used to render or provide the summary 106 and the summary stream 134.

The summary stream manager 102 is illustrated in the simplified example of FIG. 1 as a single component that includes multiple sub-components. As also described below, however, the summary stream manager 102 may be implemented using multiple devices in communication with one another.

As shown in FIG. 1, the summary stream manager 102 may include or utilize device characteristics 108 of the one or more devices represented by the device 138 in FIG. 1. For example, device characteristics may include a display size of the display 140, available fonts or formats, or available scroll rates of the device 138/display 140.

User preferences 110 may include any user preference for receiving the summary stream 134 (e.g., as reflected by device settings chosen by a user or by other operation of the device by a user). For example, the user preferences 110 may include a user preference for a slow, medium, or fast scroll rate of the summary stream 134 on the display 140. The user preferences 110 may also specify preferred fonts/formats, or preferred device(s) among a plurality of available devices. The user preferences 110 may also include a preference(s) of the user 101 with respect to available display options for displaying, controlling, or using one or both of the transcription stream 130 and/or the summary stream 134. The user preferences 110 may be input manually by the user 101, and/or inferred by the summary stream manager 102 based on actions of the user 101.

Training data 112 generally represents any training data that may be processed by a training engine 114 to train one or more machine learning (ML) models, as described herein. The training data 112 may represent one or more available repositories of labelled training data used to train such ML models, and/or may represent training data compiled by a designer of the summary stream manager 102.

A speech analyzer 116 may be configured to receive the speech 104, e.g., via a microphone or other input of the device 138, and process the speech 104 to determine relevant speech characteristics (as reflected by the audio data representing the speech). For example, the speech analyzer 116 may calculate or otherwise determine a rate, a tonality, a volume, a pitch, an emphasis, or any other characteristic of the speech 104. The speech analyzer 116 also may identify the speaker 100 individually or as a class/type of speaker. For example, the speech analyzer 116 may identify the speaker 100 as a friend of the user 101, or as a work colleague or teacher of the user 101. The speech analyzer 116 may also identify a language being spoken by the speaker 100.

An entity extraction model 118 may be trained (e.g., using the training engine 114) and otherwise configured to extract or otherwise identify entities within the transcription stream 130 or the summary stream 134. For example, such extracted content may include any type, category, or instance of information that may be structured in a known manner. Any type of facts, phrases, or other key information may be identified for extraction. Some specific but non-limiting examples of such content may include, e.g., named entities, such as persons, things, dates, times, events, locations (e.g., addresses), phone numbers, email addresses or other contact information, or the like.

An input handler 120 may be configured to receive inputs from, or related to, the display 140, and which may be associated with controlling a display and/or operations of one or both of the transcription stream 130 and the summary stream 134. A rendering engine 122 may be configured to render one or more user interface elements using the display 140, as described in more detail, below.

A transcription generator 124 may be configured to convert the spoken words of the speech 104 to transcribed text, shown in FIG. 1 as a transcription 126. For example, the transcription generator 124 may include an automatic speech recognition (ASR) engine or a speech-to-text (STT) engine.

The transcription generator 124 may include many different approaches to generating text, including additional processing of the generated text. For example, the transcription generator 124 may provide timestamps for generated text, a confidence level in generated text, and inferred punctuation of the generated text. For example, the transcription generator 124 may also utilize natural language understanding (NLU) and/or natural language processing (NLP) models, or related techniques, to identify semantic information (e.g., sentences or phrases), identify a topic, or otherwise provide metadata for the generated text.

The transcription generator 124 may provide various other types of information in conjunction with transcribed text, perhaps utilizing related hardware/software. For example, the transcription generator 124 may analyze an input audio stream to distinguish between different speakers, or to characterize a duration, pitch, speed, or volume of input audio, or other audio characteristics. For example, in some implementations, the transcription generator 124 may be understood to implement some or all of the speech analyzer 116.

In FIG. 1, the transcription generator 124 may utilize a transcription buffer 128 to output a transcription stream 130. That is, for example, the transcription generator 124 may process a live conversation, discussion, or other speech, in real time and while the speech is happening. The transcription 126 thus represents a transcription of a segment or instance of transcribed text within a time interval that occurs within a larger time period or time window of a conversation. For example, the summary 106 may represent a summarization of the transcription 126, where the transcription 126 represents a transcript of, e.g., a first 10 seconds of the speech 104.

For example, while the speaker 100 is speaking, the transcription generator 124 may output transcribed text to be stored in the transcription buffer 128. The transcribed text may be designated as intermediate or final text within the transcription buffer 128, before being available as the transcription 126/transcription stream 130. For example, the transcription generator 124 may detect the end of a sentence, a switch in speakers, a pause of pre-defined length, or other detected audio characteristic to designate a final transcription to be included in the transcription stream 130. In other examples, the transcription generator 124 may wait until the end of a defined or detected time interval to designate a final transcription of audio.

The transcription stream 130 may thus be processed by a summarizer 136 to populate a summary buffer 132 and otherwise output the summary 106/summary stream 134. The summarizer 136 may represent any trained model or algorithm designed to perform summarization. For example, the summarizer 136 may be implemented as a sequence-to-sequence generative large learning model (LLM).

In example implementations, the entity extraction model 118, the summarizer 136, and various other ML models, some examples of which are provided herein, may be trained independently, or may be trained together in groups of two or more. Training for each model may be performed with respect to, e.g., input text representing examples of the (transcribed) speech 104, relevant training data labels, a generated output of the model being trained, and a ground truth output of the model being trained (e.g., a ground truth summary output of the summarizer 136). The generated output(s) may thus be compared to the ground truth output(s) to conduct back propagation and error minimization to improve the accuracy of the trained models.

In example implementations, the summary stream manager 102 may be configured to manage various characteristics of the summary stream 134, relative to, or in conjunction with, the transcription stream 130. For example, the summary stream manager 102 may utilize characteristics of the transcription stream 130 to determine whether or when to invoke the summarizer 136 to generate the summary 106. For example, the stream manager 102 may detect sentence endings, pauses in speech, or a rate (or other characteristic) of the audio to determine whether/when to invoke the summarizer 136.

In other examples, summarization operations of the summarizer 136 may be invoked manually by the user 101, e.g., using the input handler 120, at any desired time. For example, the user 101 may utilize an available touchscreen, gesture recognition device, microphone, physical button, or other input device to manually invoke a summarization operation(s).

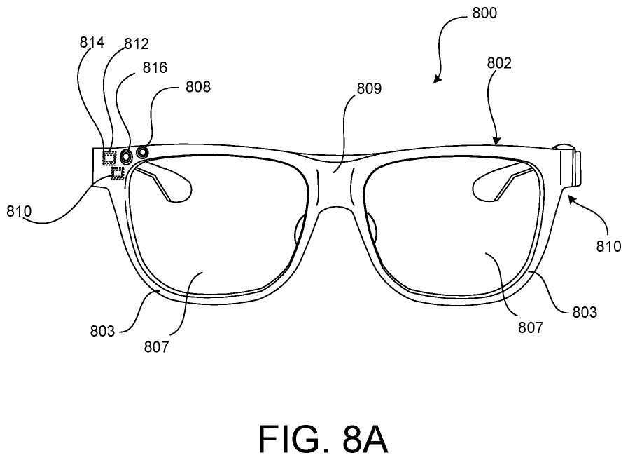

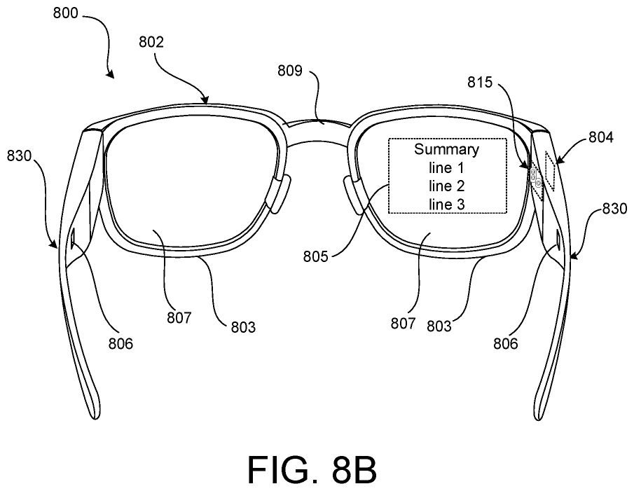

The display 140 may represent a hardware display of an associated device 138, such as a touchscreen, or a lens of a pair of smartglasses (as shown and described with respect to FIGS. 8A and 8B). Additionally, or alternatively, the display 140 may represent a software display, such as a GUI (examples of which are also provided in more detail, below). The rendering engine 122 may be implemented as being part of, or in communications with, the display 140, and may be configured to render the transcription stream 130, the summary stream 134, and a plurality of stream icons 142.

For example, the rendering engine 122 may provide the stream icons 142 to, e.g., inform the user 101 regarding a status or operation of the transcription stream 130 and the summary stream 134, or provide the user 101 with various types of functionality of, or related to, the transcription stream 130 and the summary stream 134. For example, the stream icons 142 include a stream selector 144 that is configured to provide the user 101 with an option and ability to view either or both (e.g., toggle between) the transcription stream 130 and the summary stream 134.

The rendering engine 122 may also be configured to provide a stream status indicator 146. For example, the rendering engine 122 renders the stream status indicator 146 on the GUI. For example, the stream status indicator 146 may be configured to inform the user 101 that a current portion of the summary stream 134 is being generated, while the summarizer 136 is processing a corresponding portion of the transcription stream 130.

A stream type indicator 148 may be configured to display a type of one or more streams being displayed. For example, the rendering engine 122 renders the stream type indicator 148 on the GUI. For example, if the stream selector 144 is used to select display of the transcription stream 130, then the stream type indicator 148 may provide a written identifier or a designated icon that indicates that the stream being displayed is the transcription stream 130. For example, a provided/displayed stream may be identified as a transcription stream or summary stream, or, in other examples, may be identified as being a translated stream, perhaps in conjunction with a specific language being used.

A context indicator 150 may be displayed that informs the user 101 with respect to a type or other context of, e.g., the summary 106. For example, as referenced herein, different types or contexts of summaries may include a lecture, a conversation, an ordered list, an unordered list, directions (including spatial directions), or any other type of summary. For example, the summarizer 136 may be configured (e.g., trained) to generate different type of summaries for different ones of such various contexts, which may vary in content and/or layout depending on the relevant context. In specific examples, each summary context may be associated with a corresponding context template, to which the summary 106 must conform.

In some scenarios, the summarizer 136 (or a separate ML model, such as a classifier model) may be trained using a plurality of heuristics known to be associated with different summary contexts. Such heuristics may include, e.g., content heuristics related to the speech 104, such as a length of time the speaker 100 speaks, or the user of certain recognized words (such as using first/second/third to recognize an ordered list). Context may also be trained and inferred using external heuristics, such as a current location of the device 138.

Then, at a given point in time, current values of the heuristics may collectively be used to determine a most-likely current context. In similar examples, the heuristics may collectively be used to determine a top-three (or other number) of most-likely contexts. Then, the user 101 may use the context indicator 150 to select a desired context. For example, the user 101 may select from the provided context options, or from a larger list of available contexts, or may provide a new context for which the summarizer 136 may subsequently be fine-tuned by the training engine 114, to thereby recognize the new context in the future.

A stream scroll bar 152 may be provided in conjunction with (e.g., at the same time and/or adjacent to) one or both of the transcription stream 130 and the summary stream 134. For example, the rendering engine 122 renders the scroll bar 152 on the GUI. By providing the stream scroll bar 152 in conjunction with a corresponding stream(s) being displayed, the user 101 is provided with an ability to retrieve an earlier portion of the at corresponding stream(s) in response to movement of the stream scroll bar 152.

For example, as described above, the transcription buffer 128 and the summary buffer 132 may be used to store a most-recent “n” seconds of the transcription stream 130 and the summary stream 134, respectively. For example, the display 140 may be limited by its size to displaying a certain maximum number of words/lines of the transcription stream 130 and the summary stream 134. When a quantity of the transcription stream 130 and the summary stream 134 exceeds this maximum(s), a remaining portion(s) may be retained in its corresponding buffer. Thus, the user 101 is provided with an ability to scroll back through either or both of the transcription stream 130 and the summary stream 134, depending on which is/are being displayed at a current point in time.

Additionally, as noted above, the entity extraction model 118 may identify entities within the transcription stream 130 and the summary stream 134 that may be leveraged to implement related actions, using, in FIG. 1, an action selector 154. For example, the entity extraction model 118 may identify actionable content within the summary stream 134, such as calendar items, email addresses, physical locations, or phone numbers.

Then, the rendering engine 122 may be configured to render such entities within the transcription stream 130 and the summary stream 134 in a recognizable, pre-defined manner. For example, the rendering engine 122 may render such entities using a known coloring scheme, or using other types of visual highlighting. For example, a word or phrase corresponding to an identified entity may be rendered using a text color or font type that is different from a remainder of the transcription stream 130 or the summary stream 134. In other examples, different text colors/fonts may be used to correspond to, visually identify, or otherwise provide visual differentiation of, various types of entities and/or different types of corresponding actions.

That is, in some implementations, the input handler 120 and the rendering engine 122 may be configured to facilitate or enact corresponding actions, such as generating a calendar item, or sending an email or text message, or placing a phone call, based on content of the summary stream 134. For example, the rendering engine 122 may visually identify a phone number within the summary stream 134, and the action selector 154 may identify a corresponding type of action, such as saving the phone number to a contact, or placing a phone call. When such actions are implemented, corresponding services or applications (e.g., a calendar application, or phone application) may be accessed and utilized.

Thus, for example, the input handler 120 may receive an action selection by way of the action selector 154, with respect to summary content within, e.g., the summary 106, as just referenced. The input handler 120 may interface with, or otherwise communicate with, a separate application 156, to invoke execution of the action by the application 156. For example, as may be understood from the preceding examples, the application 156 may include an email application, a phone application, a calendar application, or any application configurable to perform one or more of the types of actions described herein, or similar actions.

In the simplified example of FIG. 1, the various stream icons 142 are illustrated individually, and separately from the transcription stream 130 and the summary stream 134 within a single view of the display 140. In various implementations, however, the various stream icons 142 may be displayed in a separate display window, such as in a settings menu, or may be displayed as part of, e.g., within, one or both of the transcription stream 130 and the summary stream 134.

In other examples, functionalities of two or more of the stream icons 142 may be combined. For example, as illustrated and described below, the stream scroll bar 152 may be used as the action selector 154. For example, the stream scroll bar 152 may be used to scroll to an extracted entity (e.g., a phone number). Then, a scrollbar box or scrollbar thumb may be rendered as being selectable, so that the user 101 may click on, or otherwise select, the scrollbar box/thumb to enact a corresponding action (e.g., placing a phone call using the phone number and a phone application).

Although the transcription buffer 128 and the summary buffer 132 are described herein as memories used to provide short-term storage of, respectively, the transcription stream 130 and the summary stream 134, it will be appreciated that the same or other suitable memory may be used for longer-term storage of some or all of the transcription stream 130 and the summary stream 134. For example, the user 101 may wish to capture a summary of a lecture that the user 101 attends for later review. In these or similar situations, multiple instances or versions of the summary 106 may be provided, and the user 101 may be provided with an ability to select a most-desired summary for long term storage.

In FIG. 1, the transcription stream 130 is shown separately from the summary stream 134, and from the display 140. However, as noted above, the transcription stream 130 may be displayed on the display 140 concurrently with, or instead of, the summary stream 134, e.g., using the stream selector 144. Consequently, the transcription stream 130 and the summary stream 134 may be implemented as a single (e.g., interwoven) stream of captions, within a single window of the display 140. That is, for example, the transcription stream 130 may be displayed for a period of time, and then a summary request may be received via a suitable input device, and a corresponding summary (e.g., the summary 106) may be generated and displayed. Put another way, an output stream of the display 140 may alternate between displaying the transcription stream 130 and the summary stream 134.

In the simplified example of the stream manager 102, the various sub-components 108-136 are each illustrated in the singular, but should be understood to represent at least one instance of each sub-component. For example, two or more training engines, represented by the training engine 114, may be used to implement the various types of training used to train and deploy the entity extraction model 118 and/or the summarizer 136.

In FIG. 1, the summary stream manager 102 is illustrated as being implemented and executed using the device 138. For example, as referenced above, the device 138 may represent a handheld computing device, such as a smartphone, or a wearable computing device, such as smartglasses, smart earbuds, or a smartwatch.

The device 138 may also represent cloud or network resources in communication with a local device, such as one or more of the devices just referenced. For example, the various types of training data and the training engine 114 may be implemented remotely from the user 101 operating a local device, while a remainder of the illustrated components of the summary stream manager 102 are implemented at one or more of the local devices.

The summary 106 and/or the summary stream 134 are illustrated as being output to the display 140. As noted herein, the display 140 may be a display of the device 138, or may represent a display of a separate device(s) that is in communication with the device 138. For example, the device 138 may represent a smartphone, and the display 140 may be a display of the smartphone itself, or of smartglasses or a smartwatch worn by the user 101 and in wireless communication with the device 138.

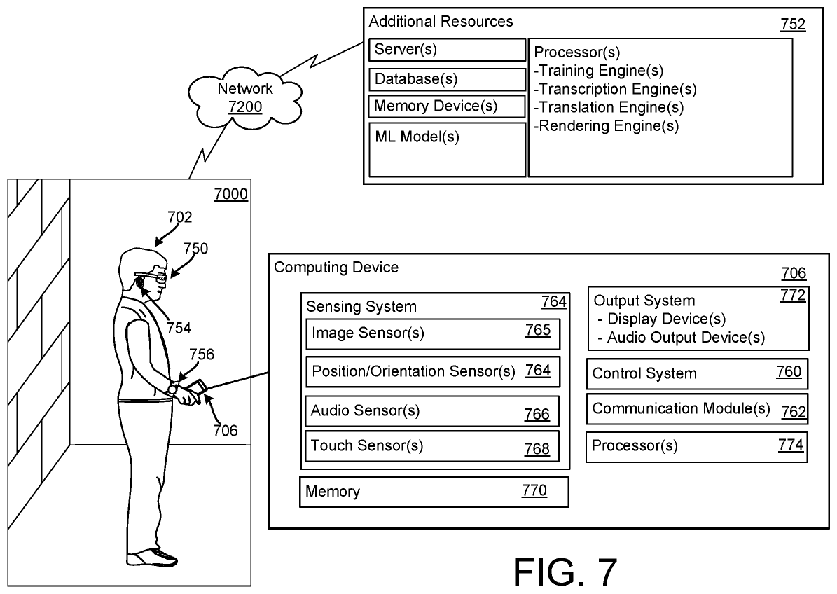

More detailed examples of devices, displays, and network architectures are provided below, e.g., with respect to FIGS. 7, 8A, and 8B. In addition, the summary 106 and the summary stream 134 (as well as the transcription 126 and the transcription stream 130) may be output via audio, e.g., using the types of smart earbuds referenced above.

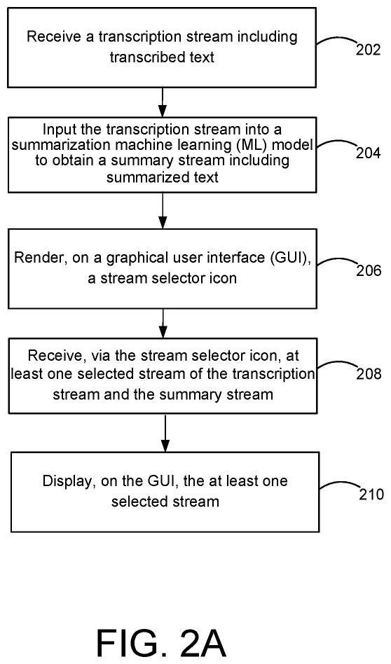

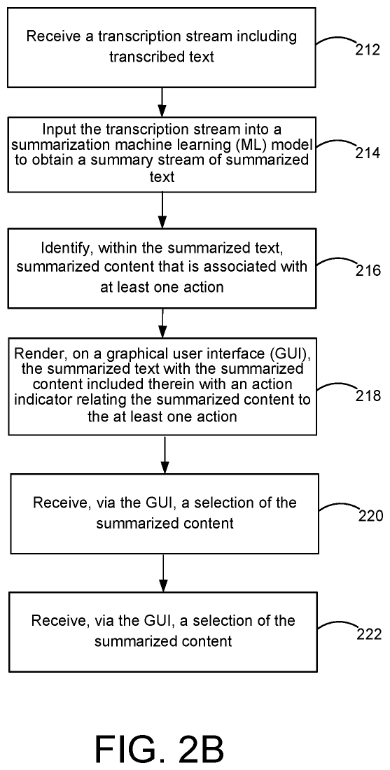

FIG. 2A is a flowchart illustrating first example operations of the system of FIG. 1. FIG. 2B is a flowchart illustrating second example operations of the system of FIG. 1. In the examples of FIGS. 2A and 2B, the various operations are illustrated as separate, sequential operations. However, in various example implementations, the operations of FIGS. 2A and/or 2B may be implemented in a different order than illustrated, in an overlapping or parallel manner, and/or in a nested, iterative, looped, or branched fashion. Further, various operations or sub-operations may be included, omitted, or substituted. The operations of FIGS. 2A and/or 2B may be performed by the system of FIG. 1, in particular by the device 138. Instructions stored in memory of the device 138 may, when executed by at least one processor of the device 138, cause the device 138 to perform the operations.

In FIG. 2A, a transcription stream including transcribed text may be received (202). For example, the transcription stream 130 may be received from the transcription generator 124, providing a transcription (text data, e.g., the transcription 126) of the speech 104 (audio data) of the speaker 100.

The transcription stream 130 (a data stream comprising text data) may be input into a summarization machine learning (ML) model, e.g., the summarizer 136, to obtain the summary stream 134 (a data stream) including summarized text, such as the summary 106 (204). For example, the summarizer 136 may execute in response to a user selection/initiation. In other example, the summarizer 136 may execute in response to characteristics of the speech 104, e.g., a detected by the speech analyzer 116. For example, the speech analyzer 116 may initiate summarization operations in response to a volume (e.g., a certain number of words) or rate (words per minute) of the speech 104.

A stream selector icon may be rendered on a graphical user interface (GUI) (206). For example, the rendering engine 122 may render the stream selector 144 as one of the stream icons 142 described above. As described and illustrated below, the stream selector 144 may include a toggle or other selector icon for switching between a transcription mode (in which the transcription stream 130 is displayed) and a summary mode (in which the summary stream 134 is displayed). In other examples, the stream selector 144 may include other GUI techniques for selecting one or both of the transcription stream 130 and the summary stream 134, such as a drop-down menu, checkbox, pop-up window, or other suitable technique.

At least one selected stream of the transcription stream and the summary stream may be received via the stream selector icon (208), e.g., by user interaction with the stream selector icon. For example, the user 101 may prefer, at a given time or in a given context, to view the summary stream 134, and may toggle the stream selector 144 accordingly. At any time thereafter, the user 101 may prefer to switch to viewing the transcription stream 130, or to viewing both the transcription stream 130 and the summary stream 134.

The at least one selected stream may thus be displayed on the GUI (210). For example, when selected, the summary stream 134 may be displayed on the GUI of the display 140. In more particular examples, as described herein, the display 140 may be included as part of smartglasses or other HMD worn by the user 101

Accordingly, the user 101 may be provided with a most-convenient and most-preferred display of transformations of the speech 104 at any given time. As described herein, in conjunction with such displays, the user 101 may be provided with supplemental displays that further facilitate and understanding and convenience of the user 101. For example, the stream status indicator 146 may provide a status of operations of the summarizer 136, particularly when there is a latency between receipt of the speech 104 and the summary 106. For example, the stream status indicator 146 may display “Summarizing . . . ” or a pre-defined icon indicating that summarization is occurring. Further, the stream type indicator 148 may display an indication to the user 101 as to whether a stream currently being displayed is the transcription stream 130 or the summary stream 134.

In the example of FIG. 2B, similar to FIG. 2A, a transcription stream including transcribed text may be received (212). For example, the transcription stream 130 may be received from the transcription generator 124, providing a transcription (e.g., the transcription 126) of the speech 104 of the speaker 100. As also described with respect to FIG. 2A, the transcription stream 130 may be input into a summarization machine learning (ML) model, e.g., the summarizer 136, to obtain the summary stream 134 including summarized text, such as the summary 106 (214).

Within the summarized text, summarized content that is associated with at least one action may be identified (216). For example, the entity extraction model 118 may identify named entities, within either the transcription 126 or the summary 106, as summarized content pre-designated as being associated with an action that is available to be performed. For example, such summarized content may include entities such as persons, corporations, phone numbers, dates, locations, or events, to provide a few non-limiting examples. Corresponding actions refer to any automated actions that may be associated with at least one of the entities (or with other summarized content or type of summarized content), and that may be pre-defined as being available for execution, e.g., in response to a selection by the user 101, or in response to some other trigger.

The summarized text may be rendered on a graphical user interface (GUI) with the summarized content included therein, with an action indicator relating the summarized content to the at least one action (218). For example, the rendering engine 122 may be configured to render the summary stream 134, including the summary 106. The summary 106 may include specific summary content (e.g., a specific word, phrase, name, or number) that is visually indicated as being associated with a corresponding action. For example, a visual action indicator such as a color, font size, font type, highlighting, or other visual indication or visual differentiation may be provided with respect to the summary content associated with an action that may be taken.

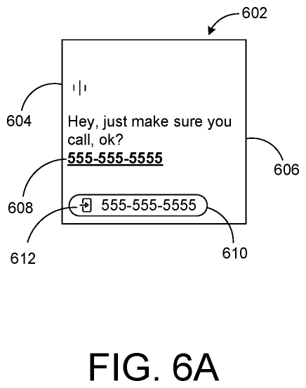

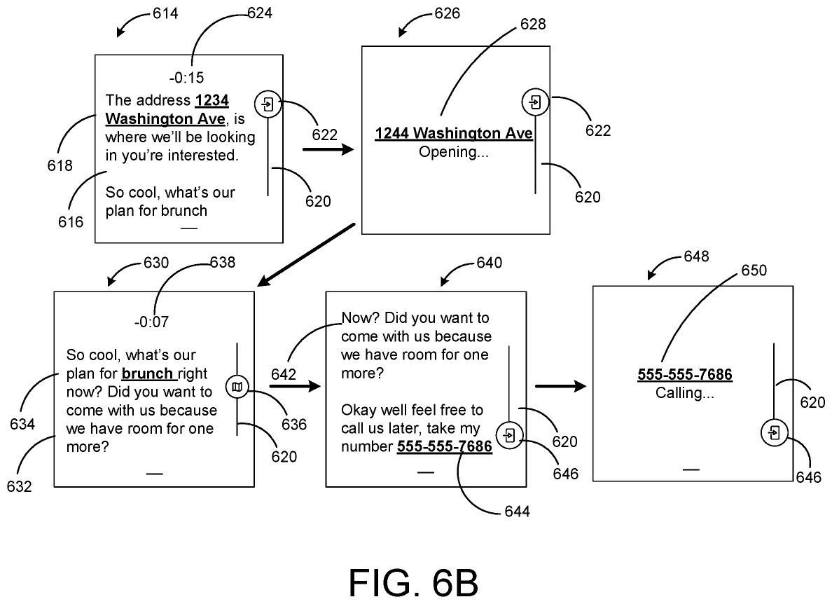

A selection of the summarized content may be received via the GUI (220). For example, the input handler 120 may be configured to receive a selection of the action selector 154 by the user 101. The action selector 154 may include simply clicking on, or otherwise selecting, the visually indicated summary content. Various additional example selection techniques are referenced below, e.g., with respect to FIGS. 8A and 8B, or would be apparent. In more specific examples, as illustrated and described with respect to FIG. 6B, the stream scroll bar 152 may be combined with the action selector 154, e.g., by making a scroll button or other portion of the stream scroll bar 152 selectable. Then, when the scroll button is aligned with the summary content rendered within the summarized text, selection of the selectable scroll button may be received as an invocation of the at least one action (and/or as a selection of the summary content). In still other examples, the summary content may be recognized and selected by the input handler 120 and/or the rendering engine 122. For example, generation of a contact card for the speaker 100 (or other action) may occur by default and without requiring the user 101 to manually perform an action selection. Such default operations may be configured by the user 101 and/or by a designer of the summary stream manager 102.

The at least one action may be executed in response to the selection (222). For example, the input handler 120 may be configured to interact with the application 156 to invoke the at least one action. The rendering engine 122 may render, on the display 140, one of various indications that demonstrate that the action has been invoked, is being executed, and/or has been completed.

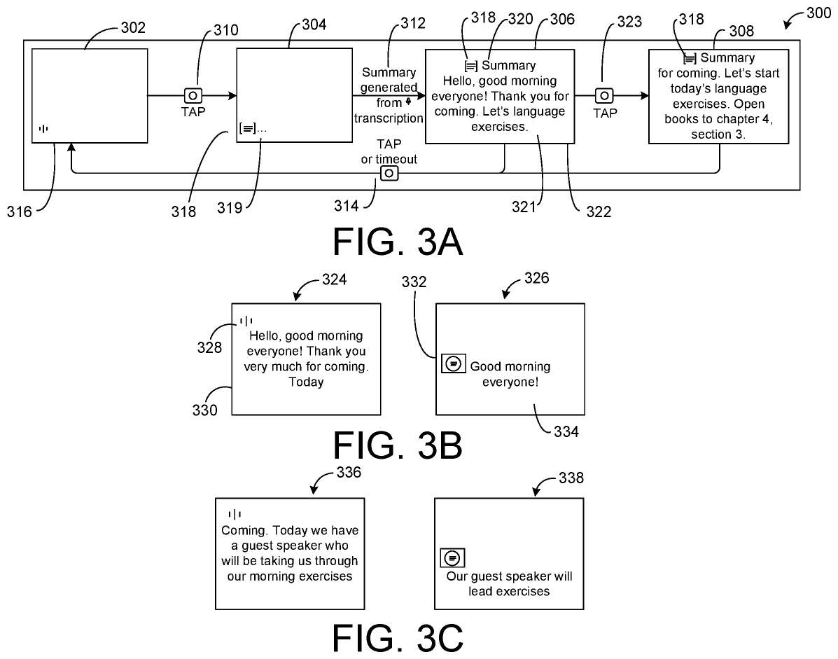

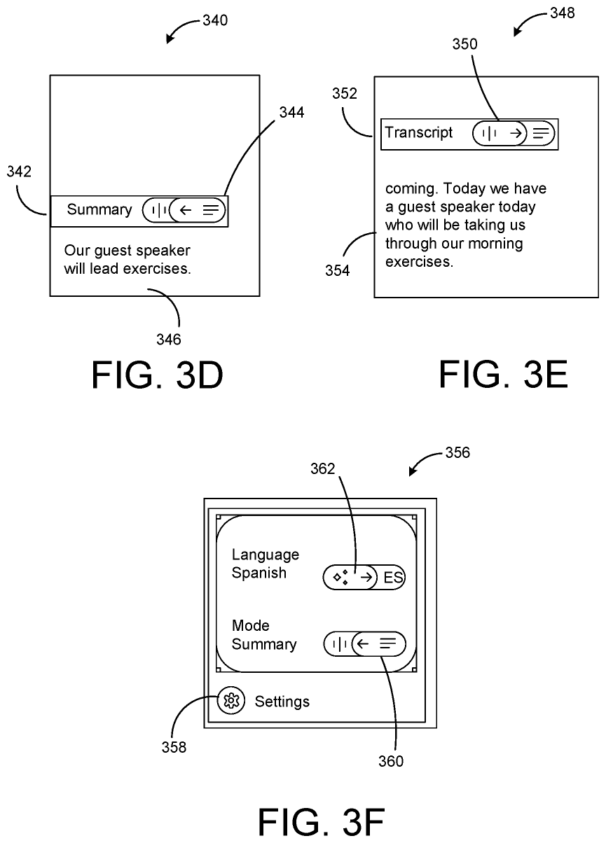

FIG. 3A is sequence of screenshots 300 illustrating example operations of the system of FIG. 1. In the example of FIG. 3, a first screenshot 302 at a first time illustrates available screen area for displaying text (e.g., transcribed or summarized), but in which no text is currently being displayed. A transcript icon 316 indicates potential availability of transcribed text, e.g., notifies the user 101 that the speech 104 is heard and is being processed/transformed. For example, the transcript icon 316 may indicate that transcribed text is available (e.g., within the transcription buffer 128) but not currently selected for viewing, or may indicate that speech 104 has been received and is currently in the process of being transcribed for display. The transcript icon 316 thus may be understood to represent an example implementation of the stream type indicator 148 of FIG. 1.

In response to a tap 310 or other user selection/request for a summary as received at the input handler 120 of FIG. 1, a second screenshot 304 illustrates a summary icon 318, representing another example implementation of the stream type indicator 148 of FIG. 1. Screenshot 304 further illustrates a processing indicator 319, which indicates to the user 101 that the summary request (e.g., the tap 310) has been received and that summarization is in process. In other words, a latency may be introduced as the user 101 waits for the transcript to finalize, and then for the summarizer 136 to complete summarization operations. During this delay, the processing indicator 319 may be used to indicate to the user 101 that speech 104 has been detected for transcription, that the summarizer 136 has been invoked, and that a summary is forthcoming. In the example of FIG. 3A, the processing indicator 319 is illustrated as ellipses, but any suitable and pre-defined indicator may be used. More generally, the processing indicator 319 may be understood to represent an example implementation of the stream status indicator 146 of FIG. 1.

For example, if the user 101 is wearing smartglasses (e.g., as described in FIGS. 8A and 8B), the user 101 may tap the smartglasses to request a summary, or may use any other suitable and available input mechanism of the smartglasses. In other examples, summarization may be initiated automatically, in response to external environmental conditions of the user 101, including, e.g., characteristics of the speech 104 as determined by the speech analyzer 116.

Related summarization processing 312 may be performed by the summary stream manager 102 as described above. For example, the summarizer 136 may process the transcription 126 (which is not currently selected for display) from within the transcription buffer 128.

In a screenshot 306, the summary icon 318 is illustrated with a header “Summary” 320, and a body 321 of a first portion of a summary produced by the summarizer 136. An arrow 322 indicates availability of a paginated interface, i.e., that the summary body 321 may extend beyond an available screen area of the screenshot 306. Accordingly, the user 101 may provide another tap 323, or other suitable input, to advance to a subsequent summary portion, as shown in the screenshot 308. Then, following another tap (or timeout) 314, the process flow of FIG. 3A may return to the status of the screenshot 302. Thus, FIG. 3A illustrates that transcribed text may continuously be summarized and presented to the user 101, as speech 104 is received/available.

FIG. 3B illustrates a pair of screenshots of the system of FIG. 1 at a first time. In FIG. 3B, a screenshot 324 displays a running transcript 330, while a screenshot 326 displays a summary 334 of the running transcript 330. A transcript icon 328 in the screenshot 324 identifies the transcript 330 as such, while a summary icon 332 in the screenshot 326 identifies the summary 334. As shown, the transcript “Hello, good morning everyone! Thank you very much for coming. Today” has been summarized as “Good morning everyone!”

FIG. 3C illustrates the pair of screenshots of FIG. 3B at a second time. In FIG. 3C, a screenshot 336 illustrates an updated/more current transcript of “coming. Today we have a guest speaker who will be taking us through our morning exercises.” A screenshot 338 illustrates a corresponding summary of “Our guest speaker will lead exercises.”

The screenshots 324/336 therefore illustrate real-time, word for word presentation and layout of transcribed speech, prioritizing low latency delivery of information in full form, in which words are presented as soon as they are available, and with punctuation being added. Meanwhile, the screenshots 326/338 illustrate summaries which are provided with an additional latency that is imparted by operations of the summarizer 136. To minimize distractions and enhance readability of such summaries, the summarizer 136 and/or the rendering engine 122 may add an additional latency beyond the latency caused by summarizer operations, in order to provide a segment or chunk of summarized text at once (rather than as summarized words become available). For example, summaries may be provided when a period is encountered in a summary, or when an entirety of a segment of a transcription is summarized.

Thus, FIGS. 3B and 3C illustrate examples in which both a running transcript and a corresponding summary are displayed. Such dual displays may be provided vertically or horizontally with respect to one another, or in any suitable configuration. The running transcript of screenshots 324, 336 may be distinguished from the running summary of 326, 338 by any suitable visual indication(s), including, e.g., color, font, or size, in addition to the user of the summary icon 332 and the transcript icon 328. In this way, the user 101 will consistently and clearly be aware which text is transcribed/summarized, in case, e.g., summarization errors occur.

In many contexts, however, it may be difficult, problematic, or undesired by the user 101 to display both a running transcript and a running summary. For example, in the context of eyewear with a small field-of-view and limited display resolution, it may be impractical to display both the running transcript and the running summary. Consequently, as described above with respect to the stream selector 144 of FIG. 1, the user 101 may be provided with an ability to choose either the running transcript or the running summary at a given point in time.

For example, in FIG. 3D, which illustrates a first alternate embodiment of the example of FIG. 3C, a screenshot 340 includes a header 342 with a stream toggle 344 as an example of the stream selector 144 of FIG. 1. As shown, the toggle 344 is a selectable, two-position switch that can be set to either a transcription mode/transcription position (represented by the transcription icon 328 of FIG. 3B) or a summary mode/summary position (represented by the summary icon 332 of FIG. 3B). In the example, the stream toggle 344 is set to summary mode, so that a summary 346 (similar to the screenshot 338 of FIG. 3C) is illustrated, and the header 342 is labeled Summary.

In FIG. 3E, a screenshot 348 illustrates an example in which a toggle 350 (which is similar to, or the same as, the toggle 344, but numbered differently for clarity) is set to a transcript mode, so that a header 352 is labeled Transcript, and a transcript 354 is displayed that corresponds to the transcript of the screenshot 336 of FIG. 3C.

In the examples of FIGS. 3D and 3E, the toggle 344/350 is illustrated concurrently with provided text (e.g., either the summary 346 or the transcript 354). In alternative implementations, however, the toggle 344/350 may be provided in a separate screen, e.g., in a settings menu.

For example, FIG. 3F illustrates a screenshot 356 of a settings menu that may be used in the system of FIG. 1. For example, the settings menu of FIG. 3F may be accessed by the user 101 using a settings icon 358 that may be displayed in place of the header 342 of FIG. 3D (or the header 352 of FIG. 3E). By selecting the settings icon 358 and accessing the settings menu of the screenshot 356, the user 101 may access multiple tools for managing preferences related to the transcription stream 130 and/or the summary stream 134 of FIG. 1.

For example, as shown, a stream toggle 360 may be provided in the context of the settings menu. At the same time, a translation toggle 362 may be provided, with which the user 101 may choose to receive one of a number of available translations of, e.g., the transcript 126 and/or the summary 106 of FIG. 1, or any of the preceding transcripts/summaries of FIGS. 3A-3E. In the specific example of FIG. 3F, the translation toggle 362 has an option to be set to Spanish, but any available language may be provided.

Once selected for translation, either or both of a transcription or summary may be translated. For example, the at least one selected stream may be translated, using a translation engine (of the device 138 or another device communicatively connected with the device 138) into a selected language for display on the GUI. For example, in the example of FIG. 3F, the settings are for summary mode in which the summary is provided in English, but if the translation toggle 362 is switched by the user 101 to Spanish, the summary will be provided in Spanish. Similarly the stream toggle 360 may be set to transcription, and the setting of the translation toggle 362 will dictate whether the transcription is provided in English or Spanish.

Described types of real-time speech-to-text processing may thus be implemented to provide multiple types of transformations of received speech, including transcription, translation, summarization, or combinations thereof. The various transformations may inherently introduce variance in their properties related to presentation in a user interface, including, e.g., latency, length/paging, formatting, and/or additional metadata. Moreover, each of these transformations may have multiple types of transformations, based on, e.g., various defined contexts. These variations may be implemented using described techniques, in order to present all such transformations within an available user interface in an effective way, particularly when screen real estate is limited (such as is the case with smartglasses and other wearable devices).

For example, factors such as contextual signals of a surrounding environment, direct input as specified from the user 101, or inferred context from the speech itself, may influence a type of transformation applied, as well as an appropriate presentation strategy. For example, as referenced above, different types of summaries may be implemented by the summarizer 136, such as summaries for lectures, conversations, directions, or ordered/unordered lists. These and various other contexts may be defined, and, as just referenced, may be determined by, e.g., the speech analyzer 116, or specified by the user 101. For example, the context indicator 150 of FIG. 1 may be used by the user 101 to select, via the input handler 120, a desired context. In other examples, the speech analyzer 116 may determine an appropriate context, which may then be displayed explicitly or implicitly within a resulting summary.

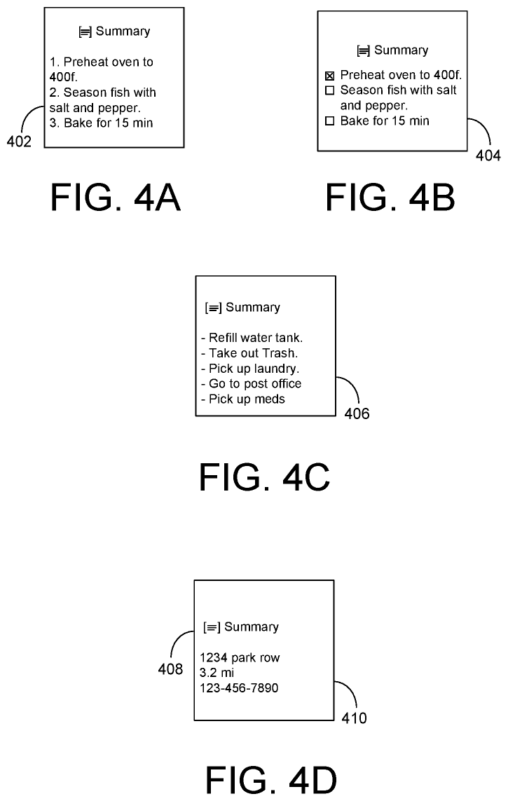

FIGS. 4A-4D illustrate examples of various strategies for layout and interaction mechanics for multiple types (contexts) of summaries. For example, FIG. 4A illustrates a summary 402 as an ordered list of directions for cooking a meal, including step 1 of preheating an oven, step 2 of seasoning fish, and step 3 of baking for 15 minutes. FIG. 4B illustrates an alternate example of the same summary, but as a summary 404 with interactive checkboxes rather than numbers of the numbered list of FIG. 4A.

In contrast, FIG. 4C presents an example summary 406, which is an unordered list of action items to be performed. Although not shown separately, the unordered list of FIG. 4C may also be presented with interactive checkboxes for the user to utilize in indicating completion of each item.

In FIG. 4D, a summary header 408 explicitly sets out a relevant context of a business name (Mike's Bistro) with a summary 410 that includes location, distance, and contact information (e.g., phone number). In other words, in FIG. 4D, the summary header 408 is used as an explicit implementation of the context indicator 150 of FIG. 1.

FIGS. 4A-4D thus provide non-limiting examples of available summary types, in addition to the previously-provided examples of FIGS. 3A-3F, which may be understood to be provided as default summary type(s) of, e.g., conversation, or lecture. In some implementations, a settings menu for setting summary preferences or contexts may be used, similar to the settings menu of FIG. 3E. For example, a settings menu may be used to designate a work or social setting, a single person or group setting, an indoor/outdoor setting, or any suitable context information for which the summarizer 136 may be trained. Consequently, such a settings menu may also include settings for the various summary types/contexts of FIGS. 4A-4D, including ordered list, unordered list, directions, or location/contact information.

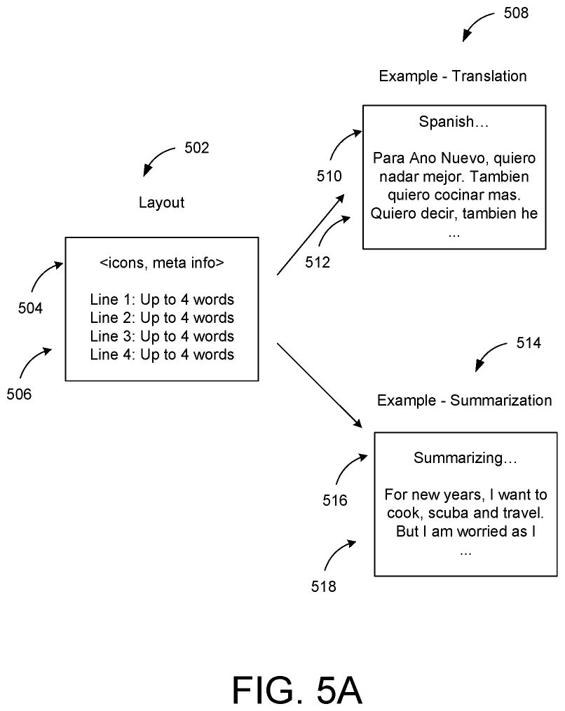

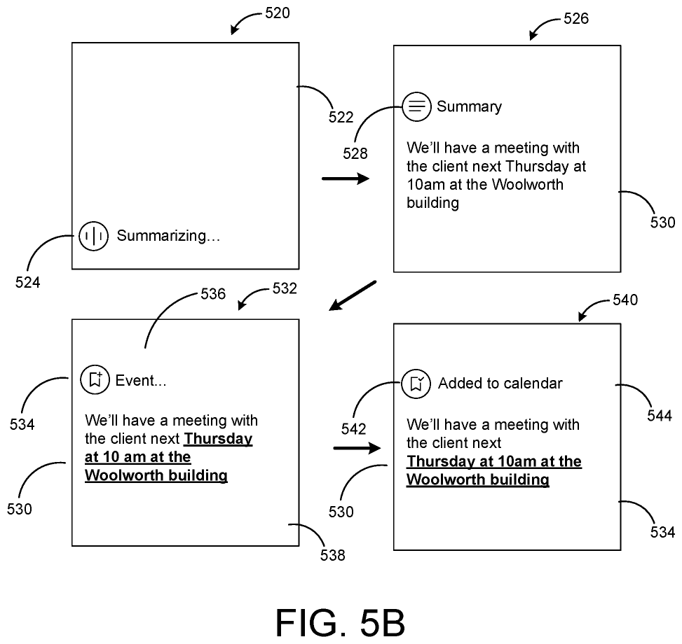

FIG. 5A illustrates example display layouts of the system of FIG. 1. In the example of FIG. 5A, a layout template 502 includes a header portion 504 and a body portion 506. As shown, the header portion 504 may be used to display one or more icons and/or related meta information or metadata, while the body portion 506 may include a specified number of lines (e.g., lines 1-4), each with a specified number of words (e.g., 4 words each), which are available, e.g., to scroll through the summary stream 134 of FIG. 1.

The layout template 502 may be constrained or otherwise defined using one or more of the device characteristics 108 and/or the user preferences 110 in FIG. 1. For example, the device characteristics 108 may specify maximum values of, e.g., number of lines and/or number of words per line, which may directly or indirectly impact other parameters, such as font size. The device characteristics 108 may also specify a minimum or maximum scroll rate of the layout template 502, along with any other display parameters and associated minimum, maximum, or optimal value(s).

The user preferences 110 may thus specify preferred values of the user 101 within the constraints of the device characteristics 108. For example, the user preferences 110 may specify fewer than four lines in the layout template 502, or fewer than 4 words per line (e.g., so that a size of each word may be larger than in the example of FIG. 5.). The user preferences 110 may also specify a scroll rate experienced by the user 101, where the scroll rate may be designated as slow/medium/fast (or between values ranging between 0 and 1) defined relative to minimum/maximum available scroll rates of a relevant device/display.

The header 504 may include virtually any information that may be useful to the user 101 in interpreting, understanding, or otherwise using the summary stream provided in the layout body 506. For example, as shown in an example layout 508, a header 510 indicates that a body portion 512 is being rendered in Spanish, and in conformance with body portion 506 of the layout template 502.

In a further example layout 514, a header 516 indicates that summarization operations are processing and/or have been processed. For example, as referenced above, in addition to indicating that summarization is being performed, there may be a delay associated with inputting the transcription 126 and outputting the summary 106, and the header 516 may be useful in conveying a corresponding summarization status to the user 101, until a summary is ready to be included within a body portion 518.

FIG. 5B illustrates a sequence of screenshots demonstrating action selection from summarized content. That is, with referenced back to FIG. 1, FIG. 5B illustrates example operations of the entity extraction model 118 in recognizing and identifying entities within either or both of the transcription 126 and the summary 106, for which one or more actions may then be taken (e.g., with respect to the application 156) through the use of the input handler 120.

In FIG. 5B, a screenshot 520 illustrates a body area 522 and a header 524 of the type of headers described and illustrated above, in which an icon, header text, and status indicator (ellipses) are used to indicate that a transcription is available and a summarization thereof is being processed.

In a subsequent screenshot 526, a header 528 indicates that a summary is being provided, and the corresponding summary 530 is rendered. Specifically, the rendered summary 530 states, as shown, “We'll have a meeting with the client next Thursday at 10 am at the Woolworth building.”

In subsequent screenshot 532, a header includes an action selector 534 and an action indicator 536. That is, the action selector 534 and the action indicator 536 represent example implementations of the action selector 154 of FIG. 1. In the example of FIG. 5B, the action indicator 536 is the word ‘event,’ indicating that the entity extraction model 118 has identified an event 538 within the summary 530 of “Thursday at 10 am at the Woolworth building.” Then, in a subsequent screenshot 540, the action selector 534 (numbered as action selector 542 for clarity) is visually indicated to have been selected by the user 101, and an action result 544 of “Added to Calendar” is displayed, indicating that the event 538 has been added to a calendar (as the application 156 of FIG. 1) of the user 101.

FIG. 6A is an example screenshot of an alternate embodiment for action selection from summarized content. In the example of FIG. 6A, a screenshot 602 includes a transcript icon 604 indicating that a body 606 of text is a real-time transcription of live speech, e.g., the speech 104 of FIG. 1. The entity extraction model 118 has identified a phone number 608, which may be visually highlighted to indicate its status as being an actionable item. Then, an action selector 612 may be provided separately from the phone number 608, in conjunction with reproduced phone number 610 for ease of recognition/selection by the user 101.

FIG. 6B illustrates a sequence of screenshots demonstrating action selection from summarized content using a scrollbar. In FIG. 6B, a screenshot 614 includes a text body 616 that may represent transcribed or summarized text, from which an address entity 618 of “1244 Washington Ave.” has been identified and visually highlighted by the entity extraction model 118 as representing an actionable item.

A scroll bar 620, as an example of the stream scroll bar 152 of FIG. 1, includes a scroll button 622 that is implemented as an example of the action selector 154. In other words, the scroll button 622, as illustrated, may be implemented as an action selector that is analogous to the action selector 612 of FIG. 6A.

As described with respect to the stream scroll bar 152 of FIG. 1, the scroll bar 620 may be used to scroll through text within either the transcription buffer 128 or the summary buffer 132, depending on whether the user has used the stream selector 144 (not shown in FIG. 6B) to select a transcription or summary mode. Accordingly, a timestamp 624 may be provided in conjunction with the scroll bar 620 to indicate an extent to which the user 101 has scrolled backwards with respect to the provided text. In the screenshot 614, the timestamp 624 indicates that the user 101 has scrolled back 15 seconds from most-recent available text.

To select the actionable item of the address entity 618, the user 101 may move/scroll the scroll button 622 to be aligned with the address entity 618. In other words, in the example, horizontal alignment of the scroll button 622 with the actionable address entity 618 indicates availability of the scroll button as an action selector to select the address entity 618 (as compared to other actional items/entities that may be included, as illustrated in subsequent screenshots of FIG. 6B) and cause execution of the associated action(s). For example, as shown, the scroll button 622 may be rendered as the action selector 612 of FIG. 6A, e.g., including an arrow indicating availability of an action to be taken.

Thus, upon selection of the actionable scroll button 622, a screenshot 626 indicates that the actionable address entity 618 has been selected, and action text 628 indicates that a corresponding action is being taken. For example, the action text 628 indicates that a mapped location of the address entity 618 is being opened, e.g., using a navigation application as an example of the application 156 of FIG. 1. The scroll button 622 and/or the scroll bar 620 may be visually modified (e.g., changed to a different color) by the rendering engine 122 to indicate that the specified action is in process.

In a subsequent screenshot 630, the display has returned to the previously-provided text, which has been scrolled forward in time within the relevant buffer using the scroll bar 620, to display text 632 that includes an actionable item 634 of “brunch” at a timestamp 638 of 7 seconds back from most-recent available text. In the example of the screenshot 630, the scroll button 622, which is shown as scroll button 636 for clarity, displays a different icon than the scroll button 622 of the screenshots 614, 626, which corresponds to the action selector 612 of FIG. 6A. Instead, as the scroll button 636 is not aligned with the actionable item 634 and is therefore not in an actionable or selectable state, the scroll button 636 may be rendered accordingly in a non-selectable state, e.g., using any available/designated icon such as the one shown in the screenshot 630.

Further in the examples of FIG. 6B, a screenshot 640 illustrates further scrolling through provided text, to reach a most-recent available text, so that no separate timestamp is included. In illustrated text 642, an actionable item 644 of a phone number is illustrated. As the scroll button 622, labeled as scroll button 646 for clarity, is aligned with the identified phone number, the scroll button 646 is rendered and designated as being in an actionable state, similarly to the scroll button 622. Consequently, upon selection thereof, a screenshot 648 displays text 650 indicating that the identified phone number is being called, e.g., using a phone application as the application 156 of FIG. 1.

FIG. 7 is a third person view of a user 702 (analogous to the user 101 of FIG. 1) in an ambient environment 7000, with one or more external computing systems shown as additional resources 752 that are accessible to the user 702 via a network 7200. FIG. 7 illustrates numerous different wearable devices that are operable by the user 702 on one or more body parts of the user 702, including a first wearable device 750 in the form of glasses worn on the head of the user, a second wearable device 754 in the form of ear buds worn in one or both ears of the user 702, a third wearable device 756 in the form of a watch worn on the wrist of the user, and a computing device 706 held by the user 702. In FIG. 7, the computing device 706 is illustrated as a handheld computing device, but may also be understood to represent any personal computing device, such as a table or personal computer.

In some examples, the first wearable device 750 is in the form of a pair of smart glasses including, for example, a display, one or more images sensors that can capture images of the ambient environment, audio input/output devices, user input capability, computing/processing capability and the like. Additional examples of the first wearable device 750 are provided below, with respect to FIGS. 8A and 8B.

In some examples, the second wearable device 754 is in the form of an ear worn computing device such as headphones, or earbuds, that can include audio input/output capability, an image sensor that can capture images of the ambient environment 7000, computing/processing capability, user input capability and the like. In some examples, the third wearable device 756 is in the form of a smart watch or smart band that includes, for example, a display, an image sensor that can capture images of the ambient environment, audio input/output capability, computing/processing capability, user input capability and the like. In some examples, the handheld computing device 706 can include a display, one or more image sensors that can capture images of the ambient environment, audio input/output capability, computing/processing capability, user input capability, and the like, such as in a smartphone. In some examples, the example wearable devices 750, 754, 756 and the example handheld computing device 706 can communicate with each other and/or with external computing system(s) 752 to exchange information, to receive and transmit input and/or output, and the like. The principles to be described herein may be applied to other types of wearable devices not specifically shown in FIG. 7 or described herein.

The user 702 may choose to use any one or more of the devices 706, 750, 754, or 756, perhaps in conjunction with the external resources 752, to implement any of the implementations described above with respect to FIGS. 1-6C. For example, the user 702 may use an application executing on the device 706 and/or the smartglasses 750 to receive, transcribe, and display the transcription stream 130 of FIG. 1 and/or the summary stream 134 of FIG. 1.

As referenced above, the device 706 may access the additional resources 752 to facilitate the various summarization techniques described herein, or related techniques. In some examples, the additional resources 752 may be partially or completely available locally on the device 706. In some examples, some of the additional resources 752 may be available locally on the device 706, and some of the additional resources 752 may be available to the device 706 via the network 7200. As shown, the additional resources 752 may include, for example, server computer systems, processors, databases, memory storage, and the like. In some examples, the processor(s) may include training engine(s), transcription engine(s), translation engine(s), rendering engine(s), and other such processors. In some examples, the additional resources may include ML model(s), such as the various ML models of the architectures of FIGS. 1 and/or 3.

The device 706 may operate under the control of a control system 760. The device 706 can communicate with one or more external devices, either directly (via wired and/or wireless communication), or via the network 7200. In some examples, the one or more external devices may include various ones of the illustrated wearable computing devices 750, 754, 756, another mobile computing device similar to the device 706, and the like. In some implementations, the device 706 includes a communication module 762 to facilitate external communication. In some implementations, the device 706 includes a sensing system 764 including various sensing system components. The sensing system components may include, for example, one or more image sensors 765, one or more position/orientation sensor(s) 764 (including for example, an inertial measurement unit, an accelerometer, a gyroscope, a magnetometer and other such sensors), one or more audio sensors 766 that can detect audio input, one or more touch input sensors 768 that can detect touch inputs, and other such sensors. The device 706 can include more, or fewer, sensing devices and/or combinations of sensing devices.

Captured still and/or moving images may be displayed by a display device of an output system 772, and/or transmitted externally via a communication module 762 and the network 7200, and/or stored in a memory 770 of the device 706. The device 706 may include one or more processor(s) 774. The processors 774 may include various modules or engines configured to perform various functions. In some examples, the processor(s) 774 may include, e.g, training engine(s), transcription engine(s), translation engine(s), rendering engine(s), and other such processors. The processor(s) 774 may be formed in a substrate configured to execute one or more machine executable instructions or pieces of software, firmware, or a combination thereof. The processor(s) 774 can be semiconductor-based including semiconductor material that can perform digital logic. The memory 770 may include any type of storage device or non-transitory computer-readable storage medium that stores information in a format that can be read and/or executed by the processor(s) 774. The memory 770 may store applications and modules that, when executed by the processor(s) 774, perform certain operations. In some examples, the applications and modules may be stored in an external storage device and loaded into the memory 770.

Although not shown separately in FIG. 7, it will be appreciated that the various resources of the computing device 706 may be implemented in whole or in part within one or more of various wearable devices, including the illustrated smartglasses 750, earbuds 754, and smartwatch 756, which may be in communication with one another to provide the various features and functions described herein. For example, the memory 770 may be used to implement the transcription buffer 128 and the summary buffer 132.

In FIG. 7, any audio and/or video output may be used to provide the types of summaries described herein, and associated features. For example, described techniques may be implemented in any product in which improving speech-to-text would be helpful and in which high-quality summaries would be beneficial. Beyond head-worn displays, wearables, and mobile devices, described techniques may be used in remote conferencing and web apps (including, e.g., providing captions/summaries within webconferencing software and/or pre-recorded videos).

Described techniques may also be useful in conjunction with translation capabilities, e.g., of the additional resources 752. For example, the user 702 may listen to a conversation from a separate speaker (corresponding to the speaker 100 of FIG. 1), who may be proximate to, or removed from, the user 702), where the speaker may be speaking in a first language. A translation engine of the processors of the additional resources 752 may provide automated translation of the dialogue into a native language of the user 702, and also may summarize the translated dialogue using techniques described herein.

The architecture of FIG. 7 may be used to implement or access one or more large language models (LLMs), which may be used to implement a summarizer for use in the preceding examples. For example, the Pathways Language Model (PaLM) and/or the Language Model for Dialogue Application (LaMDA), both provided by Google, Inc., may be used.

An example head mounted wearable device 800 in the form of a pair of smart glasses is shown in FIGS. 8A and 8B, for purposes of discussion and illustration. The example head mounted wearable device 800 includes a frame 802 having rim portions 803 surrounding glass portion, or lenses 807, and arm portions 830 coupled to a respective rim portion 803. In some examples, the lenses 807 may be corrective/prescription lenses. In some examples, the lenses 807 may be glass portions that do not necessarily incorporate corrective/prescription parameters. A bridge portion 809 may connect the rim portions 803 of the frame 802. In the example shown in FIGS. 8A and 8B, the wearable device 800 is in the form of a pair of smart glasses, or augmented reality glasses, simply for purposes of discussion and illustration.

In some examples, the wearable device 800 includes a display device 804 that can output visual content, for example, at an output coupler providing a visual display area 805, so that the visual content is visible to the user. In the example shown in FIGS. 8A and 8B, the display device 804 is provided in one of the two arm portions 830, simply for purposes of discussion and illustration. Display devices 804 may be provided in each of the two arm portions 830 to provide for binocular output of content. In some examples, the display device 804 may be a see through near eye display. In some examples, the display device 804 may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 807, next to content (for example, digital images, user interface elements, virtual content, and the like) output by the display device 804. In some implementations, waveguide optics may be used to depict content on the display device 804.

The example wearable device 800, in the form of smart glasses as shown in FIGS. 8A and 8B, includes one or more of an audio output device 806 (such as, for example, one or more speakers), an illumination device 808, a sensing system 810, a control system 812, at least one processor 814, and an outward facing image sensor 816 (for example, a camera). In some examples, the sensing system 810 may include various sensing devices and the control system 812 may include various control system devices including, for example, the at least one processor 814 operably coupled to the components of the control system 812. In some examples, the control system 812 may include a communication module providing for communication and exchange of information between the wearable device 800 and other external devices. In some examples, the head mounted wearable device 800 includes a gaze tracking device 815 to detect and track eye gaze direction and movement. Data captured by the gaze tracking device 815 may be processed to detect and track gaze direction and movement as a user input. In the example shown in FIGS. 8A and 8B, the gaze tracking device 815 is provided in one of two arm portions 830, simply for purposes of discussion and illustration. In the example arrangement shown in FIGS. 8A and 8B, the gaze tracking device 815 is provided in the same arm portion 830 as the display device 804, so that user eye gaze can be tracked not only with respect to objects in the physical environment, but also with respect to the content output for display by the display device 804. In some examples, gaze tracking devices 815 may be provided in each of the two arm portions 830 to provide for gaze tracking of each of the two eyes of the user. In some examples, display devices 804 may be provided in each of the two arm portions 830 to provide for binocular display of visual content.

The wearable device 800 is illustrated as glasses, such as smartglasses, augmented reality (AR) glasses, or virtual reality (VR) glasses. More generally, the wearable device 800 may represent any head-mounted device (HMD), including, e.g., a hat, helmet, or headband. Even more generally, the wearable device 800 and the computing device 706 may represent any wearable device(s), handheld computing device(s), or combinations thereof.

Use of the wearable device 800, and similar wearable or handheld devices such as those shown in FIG. 7, enables useful and convenient use case scenarios of implementations of the systems of FIGS. 1-4. For example, such wearable and handheld devices may be highly portable and therefore available to the user 702 in many different scenarios. At the same time, available display areas of such devices may be limited. For example, the display area 805 of the wearable device 800 may be a relatively small display area, constrained by an overall size and form factor of the wearable device 800.

Consequently, the user 702 may benefit from use of the various summarization techniques described herein. For example, the user 702 may engage in interactions with separate speakers, such as a lecturer or a participant in a conversation. The user 702 and the separate speaker may have varying degrees of interactivity or back-and-forth, and two or more additional speakers may be present, as well.

Using described techniques, the user 702 may be provided with dynamic, real-time summarizations during all such interactions, as the interactions are happening. For example, the speaker may speak for a short time or a longer time, in conjunction with (e.g., in response to) dialogue provided by the user 702. During all such interactions, the user 702 may be provided with useful and convenient summaries of words spoken by the separate speaker(s).

As described, the dynamic, real-time summarizations may be provided with dynamically-updated compression ratios and complexities, or may otherwise be dynamically adjusted over time and during the course of a conversation or other interaction. As a result, the user 101/702 may be provided with meaningful, situation-specific summaries that reduce a cognitive load of the user 101/702 and facilitate meaningful interactions, even when one or more participants in the interaction(s) is not a native speaker, or is currently speaking a different language, or is an expert in a field speaking to a novice in the field.

In a first example implementation, referred to herein as example 1, a computer program product is tangibly embodied on a non-transitory computer-readable storage medium and comprises instructions that, when executed by at least one computing device, are configured to cause the at least one computing device to:
receive a transcription stream including transcribed text;
input the transcription stream into a summarization machine learning (ML) model to obtain a summary stream including summarized text;
render, on a user interface (UI), a stream selector icon;
receive, via the stream selector icon, at least one selected stream of the transcription stream and the summary stream; and
cause a display, on the UI, of the at least one selected stream.

Example 2 includes the computer program product of example 1, wherein the instructions, when executed by the at least one computing device, are further configured to cause the at least one computing device to:
render the stream selector icon as a toggle having a transcription position for selecting the transcription stream and a summary position for selecting the summary stream.

Example 3 includes the computer program product of example 1 or 2, wherein the instructions, when executed by the at least one computing device, are further configured to cause the at least one computing device to:
render, using the UI and when the at least one selected stream includes the summary stream, a stream status indicator providing a status of the summary stream as currently processing the transcription stream using the summarization ML model.

Example 4 includes the computer program product of any one of the preceding examples, wherein the instructions, when executed by the at least one computing device, are further configured to cause the at least one computing device to:
render, using the UI, a stream type indicator identifying the at least one selected stream as being either the transcription stream or the summary stream.

Example 5 includes the computer program product of any one of the preceding examples, wherein the instructions, when executed by the at least one computing device, are further configured to cause the at least one computing device to:
store the transcription stream in a transcription buffer; and
store the summary stream in a summary buffer.

Example 6 includes the computer program product of any of the preceding examples, wherein the instructions, when executed by the at least one computing device, are further configured to cause the at least one computing device to:
render, using the UI, a scroll bar in conjunction with the at least one selected stream; and
retrieve an earlier portion of the at least one selected stream in response to movement of the scroll bar.

Example 7 includes the computer program product of any one of examples 1-3, 5 or 6, wherein the at least one selected stream includes both the transcription stream and the summary stream.

Example 8 includes the computer program product of any one of the preceding examples, wherein the instructions, when executed by the at least one computing device, are further configured to cause the at least one computing device to:
translate the at least one selected stream into a selected language for display using the UI.

Example 9 includes the computer program product of any one of the preceding examples, wherein the instructions, when executed by the at least one computing device, are further configured to cause the at least one computing device to:
cause the display of the at least one selected stream on a head-mounted device.

Example 10 includes the computer program product of any one of the preceding examples, wherein the instructions, when executed by the at least one computing device, are further configured to cause the at least one computing device to:
identify at least one entity within the at least one selected stream;
associate the at least one entity with at least one action;
render the at least one selected stream with the at least one entity being visually highlighted;
receive a selection of the at least one entity; and
invoke the at least one action.

In an eleventh example implementation, referred to herein as example 11, a device comprises:
at least one processor;
at least one display; and
at least one memory storing instructions, which, when executed by the at least one processor, cause the device to:
   receive a transcription stream including transcribed text;
   input the transcription stream into a summarization machine learning (ML) model to obtain a summary stream including summarized text;
   render, on a graphical user interface (GUI), a stream selector icon;
   receive, via the stream selector icon, at least one selected stream of the transcription stream and the summary stream; and
   cause a display, on the GUI, of the at least one selected stream.

Example 12 includes the device of example 11, wherein the instructions, when executed by the at least one processor, are further configured to cause the device to: render the stream selector icon as a toggle having a transcription position for selecting the transcription stream and a summary position for selecting the summary stream.

Example 13 includes the device of example 11 or 12, wherein the instructions, when executed by the at least one processor, are further configured to cause the device to:
render, using the GUI and when the at least one selected stream includes the summary stream, a stream status indicator providing a status of the summary stream as currently processing the transcription stream using the summarization ML model.

Example 14 includes the device of any one of examples 11-13, wherein the instructions, when executed by the at least one processor, are further configured to cause the device to:
render, using the GUI, a stream type indicator identifying the at least one selected stream as being either the transcription stream or the summary stream.

Example 15 includes the device of any of examples 11-14, wherein the instructions, when executed by the at least one processor, are further configured to cause the device to:
store the transcription stream in a transcription buffer; and
store the summary stream in a summary buffer.

Example 16 includes the device of any of examples 11-15, wherein the instructions, when executed by the at least one processor, are further configured to cause the device to:
render, using the GUI, a scroll bar in conjunction with the at least one selected stream; and
retrieve an earlier portion of the at least one selected stream in response to movement of the scroll bar.

In a seventeenth example implementation, referred to herein as example 17, a method comprises:
receiving a transcription stream including transcribed text;
inputting the transcription stream into a summarization machine learning (ML) model to obtain a summary stream including summarized text;
rendering, on a graphical user interface (GUI), a stream selector icon;
receiving, via the stream selector icon, at least one selected stream of the transcription stream and the summary stream; and
causing a display, on the GUI, of the at least one selected stream.

Example 18 includes the method of example 17, further comprising: rendering the stream selector icon as a toggle having a transcription position for selecting the transcription stream and a summary position for selecting the summary stream.

Example 19 includes the method of example 17 or 18, further comprising:
storing the transcription stream in a transcription buffer; and
storing the summary stream in a summary buffer.

Example 20 includes the method of any one of examples 17-19, further comprising:
rendering, using the GUI, a scroll bar in conjunction with the at least one selected stream; and
retrieving an earlier portion of the at least one selected stream in response to movement of the scroll bar.

In a twenty-first example implementation, referred to herein as example 21, a computer program product is tangibly embodied on a non-transitory computer-readable storage medium and comprises instructions that, when executed by at least one computing device, are configured to cause the at least one computing device to:
receive a transcription stream including transcribed text;
input the transcription stream into a summarization machine learning (ML) model to obtain a summary stream of summarized text;
identify, within the summarized text, summarized content that is associated with at least one action;
render, on a graphical user interface (GUI), the summarized text with the summarized content included therein with an action indicator relating the summarized content to the at least one action;
receive, via the GUI, a selection of the summarized content; and
execute the at least one action, in response to the selection.

Example 22 includes the computer program product of example 21, wherein the instructions, when executed by the at least one computing device, are further configured to cause the at least one computing device to:
identify the summarized content using an entity extraction ML model.

Example 23 includes the computer program product of example 21, wherein the instructions, when executed by the at least one computing device, are further configured to cause the at least one computing device to:
identify, within the transcribed text, transcribed content that is associated with a second action;
render, on the GUI, the transcribed text with the transcribed content included therein with a second action indicator relating the transcribed content to the second action;
receive, via the GUI, a second selection of the transcribed content; and
execute the second action, in response to the second selection.

Example 24 includes the computer program product of example 21 or 22, wherein the instructions, when executed by the at least one computing device, are further configured to cause the at least one computing device to:
store the transcription stream in a transcription buffer; and
store the summary stream in a summary buffer.

Example 25 includes the computer program product of any of examples 21-24, wherein the instructions, when executed by the at least one computing device, are further configured to cause the at least one computing device to:
render, using the GUI, a scroll bar in conjunction with the summary stream; and
retrieve an earlier portion of the summary stream in response to movement of the scroll bar.

Example 26 includes the computer program product of example 25, wherein the instructions, when executed by the at least one computing device, are further configured to cause the at least one computing device to:
detect alignment of a scroll button of the scroll bar with the summarized content within the GUI; and receive the selection using the scroll button, in conjunction with the alignment.

Example 27 includes the computer program product of any one of examples 21-26, wherein the action indicator includes visual differentiation of the summarized content relative to remaining summarized content of the summarized text.

Example 28 includes the computer program product of any one of examples 21-25 or 27, wherein the instructions, when executed by the at least one computing device, are further configured to cause the at least one computing device to:
render an action selector icon using the GUI, the action selector icon identifying a type of the at least one action; and
receive the selection via the action selector icon.

Example 29 includes the computer program product of any one of examples 21-28, wherein the instructions, when executed by the at least one computing device, are further configured to cause the at least one computing device to:
render the GUI on a display of a head-mounted device.

Example 30 includes the computer program product of any one of examples 21-29, wherein the instructions, when executed by the at least one computing device, are further configured to cause the at least one computing device to:
execute the at least one action including communicating with an application to cause the application to execute the at least one action.

In a thirty-first example implementation, referred to herein as example 31, a device comprises:
at least one processor;
at least one display; and
at least one memory storing instructions, which, when executed by the at least one processor, cause the device to:
   receive a transcription stream including transcribed text;
   input the transcription stream into a summarization machine learning (ML) model to obtain a summary stream of summarized text;
   identify, within the summarized text, summarized content that is associated with at least one action;
   render, on a graphical user interface (GUI), the summarized text with the summarized content included therein with an action indicator relating the summarized content to the at least one action;
   receive, via the GUI, a selection of the summarized content; and
   execute the at least one action, in response to the selection.

Example 32 includes the device of example 31, wherein the instructions, when executed by the at least one processor, are further configured to cause the device to:
identify the summarized content using an entity extraction ML model.

Example 33 includes the device of example 31 or 32, wherein the instructions, when executed by the at least one processor, are further configured to cause the device to:
identify, within the transcribed text, transcribed content that is associated with a second action;
render, on the GUT, the transcribed text with the transcribed content included therein with a second action indicator relating the transcribed content to the second action;
receive, via the GUI, a second selection of the transcribed content; and
execute the second action, in response to the second selection.

Example 34 includes the device of any one of examples 31-33, wherein the instructions, when executed by the at least one processor, are further configured to cause the device to:
store the transcription stream in a transcription buffer; and
store the summary stream in a summary buffer.

Example 35 includes the device of any one of examples 31-34, wherein the instructions, when executed by the at least one processor, are further configured to cause the device to:
render, using the GUI, a scroll bar in conjunction with the at least one selected stream; and
retrieve an earlier portion of the at least one selected stream in response to movement of the scroll bar.

Example 36 includes the The device of example 35, wherein the instructions, when executed by the at least one processor, are further configured to cause the device to:
detect alignment of a scroll button of the scroll bar with the summarized content within the GUI; and
receive the selection using the scroll button, in conjunction with the alignment.

In a thirty-seventh example implementation, referred to herein as example 37, a method comprises:
receiving a transcription stream including transcribed text;
inputting the transcription stream into a summarization machine learning (ML) model to obtain a summary stream of summarized text;
identifying, within the summarized text, summarized content that is associated with at least one action;
rendering, on a graphical user interface (GUI), the summarized text with the summarized content included therein with an action indicator relating the summarized content to the at least one action;
receiving, via the GUI, a selection of the summarized content; and
executing the at least one action, in response to the selection.

Example 38 includes the method of example 37, further comprising: identifying the summarized content using an entity extraction ML model.

Example 39 includes the method of example 37 or 38, further comprising:
storing the transcription stream in a transcription buffer;
storing the summary stream in a summary buffer;
rendering, using the GUI, a scroll bar in conjunction with the summary stream; and
retrieving an earlier portion of the summary stream from a corresponding buffer of the transcription buffer and the summary buffer in response to movement of the scroll bar.

Example 40 includes the method of example 39, further comprising:
detecting alignment of a scroll button of the scroll bar with the summarized content within the GUI; and
receiving the selection using the scroll button, in conjunction with the alignment.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as modules, programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor, or LED (light emitting diode)) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship with each other.

In some implementations, one or more input devices in addition to the computing device (e.g., a mouse, a keyboard) can be rendered in a display of an HMD, such as the HMD 800. The rendered input devices (e.g., the rendered mouse, the rendered keyboard) can be used as rendered in the display.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
receive a transcription stream including transcribed text;
input the transcription stream into a summarization machine learning (ML) model to obtain a summary stream including summarized text;
render, on a user interface (UI), a stream selector icon;
receive, via the stream selector icon, at least one selected stream of the transcription stream and the summary stream; and
cause a display, on the UI, of the at least one selected stream.

2. The computer program product of claim 1, wherein the instructions, when executed by the at least one computing device, are further configured to cause the at least one computing device to:
render the stream selector icon as a toggle having a transcription position for selecting the transcription stream and a summary position for selecting the summary stream.

3. The computer program product of claim 1, wherein the instructions, when executed by the at least one computing device, are further configured to cause the at least one computing device to:
render, using the UI and when the at least one selected stream includes the summary stream, a stream status indicator providing a status of the summary stream as currently processing the transcription stream using the summarization ML model.

4. The computer program product of claim 1, wherein the instructions, when executed by the at least one computing device, are further configured to cause the at least one computing device to:
render, using the UI, a stream type indicator identifying the at least one selected stream as being either the transcription stream or the summary stream.

5. The computer program product of claim 1, wherein the instructions, when executed by the at least one computing device, are further configured to cause the at least one computing device to:
store the transcription stream in a transcription buffer; and
store the summary stream in a summary buffer.

6. The computer program product of claim 1, wherein the instructions, when executed by the at least one computing device, are further configured to cause the at least one computing device to:
render, using the UI, a scroll bar in conjunction with the at least one selected stream; and
retrieve an earlier portion of the at least one selected stream in response to movement of the scroll bar.

7. The computer program product of claim 1, wherein the at least one selected stream includes both the transcription stream and the summary stream.

8. The computer program product of claim 1, wherein the instructions, when executed by the at least one computing device, are further configured to cause the at least one computing device to:
translate the at least one selected stream into a selected language for display using the UI.

9. The computer program product of claim 1, wherein the instructions, when executed by the at least one computing device, are further configured to cause the at least one computing device to:
cause the display of the at least one selected stream on a head-mounted device.

10. The computer program product of claim 1, wherein the instructions, when executed by the at least one computing device, are further configured to cause the at least one computing device to:
identify at least one entity within the at least one selected stream;
associate the at least one entity with at least one action;
render the at least one selected stream with the at least one entity being visually highlighted;
receive a selection of the at least one entity; and
invoke the at least one action.

11. A device comprising:
at least one processor;
at least one display; and
at least one memory storing instructions, which, when executed by the at least one processor, cause the device to:
receive a transcription stream including transcribed text;
input the transcription stream into a summarization machine learning (ML) model to obtain a summary stream including summarized text;
render, on a graphical user interface (GUI), a stream selector icon;
receive, via the stream selector icon, at least one selected stream of the transcription stream and the summary stream; and
cause a display, on the GUI, of the at least one selected stream.

12. The device of claim 11, wherein the instructions, when executed by the at least one processor, are further configured to cause the device to:
render the stream selector icon as a toggle having a transcription position for selecting the transcription stream and a summary position for selecting the summary stream.

13. The device of claim 11, wherein the instructions, when executed by the at least one processor, are further configured to cause the device to:
render, using the GUI and when the at least one selected stream includes the summary stream, a stream status indicator providing a status of the summary stream as currently processing the transcription stream using the summarization ML model.

14. The device of claim 11, wherein the instructions, when executed by the at least one processor, are further configured to cause the device to:
render, using the GUI, a stream type indicator identifying the at least one selected stream as being either the transcription stream or the summary stream.

15. The device of claim 11, wherein the instructions, when executed by the at least one processor, are further configured to cause the device to:
store the transcription stream in a transcription buffer; and
store the summary stream in a summary buffer.

16. The device of claim 11, wherein the instructions, when executed by the at least one processor, are further configured to cause the device to:
render, using the GUI, a scroll bar in conjunction with the at least one selected stream; and
retrieve an earlier portion of the at least one selected stream in response to movement of the scroll bar.

17. A method comprising:
receiving a transcription stream including transcribed text;
inputting the transcription stream into a summarization machine learning (ML) model to obtain a summary stream including summarized text;
rendering, on a graphical user interface (GUI), a stream selector icon;
receiving, via the stream selector icon, at least one selected stream of the transcription stream and the summary stream; and
causing a display, on the GUI, of the at least one selected stream.

18. The method of claim 17, further comprising:
rendering the stream selector icon as a toggle having a transcription position for selecting the transcription stream and a summary position for selecting the summary stream.

19. The method of claim 17, further comprising:
storing the transcription stream in a transcription buffer; and
storing the summary stream in a summary buffer.

20. The method of claim 17, further comprising:
rendering, using the GUI, a scroll bar in conjunction with the at least one selected stream; and
retrieving an earlier portion of the at least one selected stream in response to movement of the scroll bar.

21. A computer program product, the computer program product being tangibly embodied on a non-transitory computer-readable storage medium and comprising instructions that, when executed by at least one computing device, are configured to cause the at least one computing device to:
receive a transcription stream including transcribed text;
input the transcription stream into a summarization machine learning (ML) model to obtain a summary stream of summarized text;
identify, within the summarized text, summarized content that is associated with at least one action;
render, on a graphical user interface (GUI), the summarized text with the summarized content included therein with an action indicator relating the summarized content to the at least one action;
receive, via the GUI, a selection of the summarized content; and
execute the at least one action, in response to the selection.

22. The computer program product of claim 21, wherein the instructions, when executed by the at least one computing device, are further configured to cause the at least one computing device to:
identify the summarized content using an entity extraction ML model.

23. The computer program product of claim 21, wherein the instructions, when executed by the at least one computing device, are further configured to cause the at least one computing device to:
identify, within the transcribed text, transcribed content that is associated with a second action;
render, on the GUI, the transcribed text with the transcribed content included therein with a second action indicator relating the transcribed content to the second action;
receive, via the GUI, a second selection of the transcribed content; and
execute the second action, in response to the second selection.

24. The computer program product of claim 21, wherein the instructions, when executed by the at least one computing device, are further configured to cause the at least one computing device to:
store the transcription stream in a transcription buffer; and
store the summary stream in a summary buffer.

25. The computer program product of claim 21, wherein the instructions, when executed by the at least one computing device, are further configured to cause the at least one computing device to:
render, using the GUI, a scroll bar in conjunction with the summary stream; and
retrieve an earlier portion of the summary stream in response to movement of the scroll bar.

26. The computer program product of claim 25, wherein the instructions, when executed by the at least one computing device, are further configured to cause the at least one computing device to:
detect alignment of a scroll button of the scroll bar with the summarized content within the GUI; and
receive the selection using the scroll button, in conjunction with the alignment.

27. The computer program product of claim 21, wherein the action indicator includes visual differentiation of the summarized content relative to remaining summarized content of the summarized text.

28. The computer program product of claim 21, wherein the instructions, when executed by the at least one computing device, are further configured to cause the at least one computing device to:
render an action selector icon using the GUI, the action selector icon identifying a type of the at least one action; and
receive the selection via the action selector icon.

29. The computer program product of claim 21, wherein the instructions, when executed by the at least one computing device, are further configured to cause the at least one computing device to:
render the GUI on a display of a head-mounted device.

30. The computer program product of claim 21, wherein the instructions, when executed by the at least one computing device, are further configured to cause the at least one computing device to:
execute the at least one action including communicating with an application to cause the application to execute the at least one action.

31.-40. (canceled)
